(19) United States
(12) Patent Application Publication
(10) Pub. No.: US 2022/0237330 A1
(43) Pub. Date: Jul. 28, 2022

(54) ELECTRONIC APPARATUS

(71) Applicant: KYOCERA Document Solutions Inc., Osaka (JP)

(72) Inventor: Masato Shiose, Osaka (JP)

(21) Appl. No.: 17/577,171

(22) Filed: Jan. 17, 2022

(30) Foreign Application Priority Data
Jan. 26, 2021 (JP) 2021-010700

(51) Int. Cl. G06F 21/72; G06F 21/57

(52) U.S. Cl. CPC G06F 21/72; G06F 2221/034; G06F 21/575

(57) ABSTRACT

An electronic apparatus includes a non-rewritable memory part and a security setting unit. The non-rewritable memory part is configured to store a usage environment code. The security setting unit is configured to read the usage environment code from the memory part, select a security algorithm in accordance with a value of the usage environment code, and set the selected security algorithm to the electronic apparatus.

### CROSS-REFERENCE TO RELATED APPLICATIONS

This application relates to and claims priority rights from Japanese Patent Application No. 2021-010700, filed on Jan. 26, 2021, the entire disclosures of which are hereby incorporated by reference herein.

### BACKGROUND

### 1. Field of the Present Disclosure

The present disclosure relates to an electronic apparatus.

### 2. Description of the Related Art

An image forming apparatus determines whether the apparatus performs secure boot or not on the basis of a security-strength setting value described in a boot ROM.

A microcomputer includes a built-in flash memory that includes a non-rewritable area, in which a security setting flag is described, and a security function is enabled or disabled in accordance with a value of the security setting flag.

As mentioned, it is possible to write such security setting value in a ROM in an electronic apparatus and apply a security algorithm corresponding to the setting value to the electronic apparatus.

However, different security algorithms should be applied so as to correspond to usage environments, and therefore, an operator is required to (a) decide a security algorithm to be applied to an electronic apparatus on the basis of a usage environment at a time point before an end user starts to use the electronic apparatus, for example, at factory shipment of the electronic apparatus or at delivery to the end user, and (b) perform a manual operation to individually write the security setting value to such ROM or the like; and consequently, such cumbersome setting operation is required at a time point before the end user starts to use the electronic apparatus, and incorrect setting may occur due to such setting operation.

### SUMMARY

An electronic apparatus according to an aspect of the present disclosure includes a non-rewritable memory part and a security setting unit. The non-rewritable memory part is configured to store a usage environment code. The security setting unit is configured to read the usage environment code from the memory part, select a security algorithm in accordance with a value of the usage environment code, and set the selected security algorithm to the electronic apparatus.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an electronic apparatus according to an embodiment of the present disclosure.

### DETAILED DESCRIPTION

Hereinafter, an embodiment according to an aspect of the present disclosure will be explained with reference to drawings.

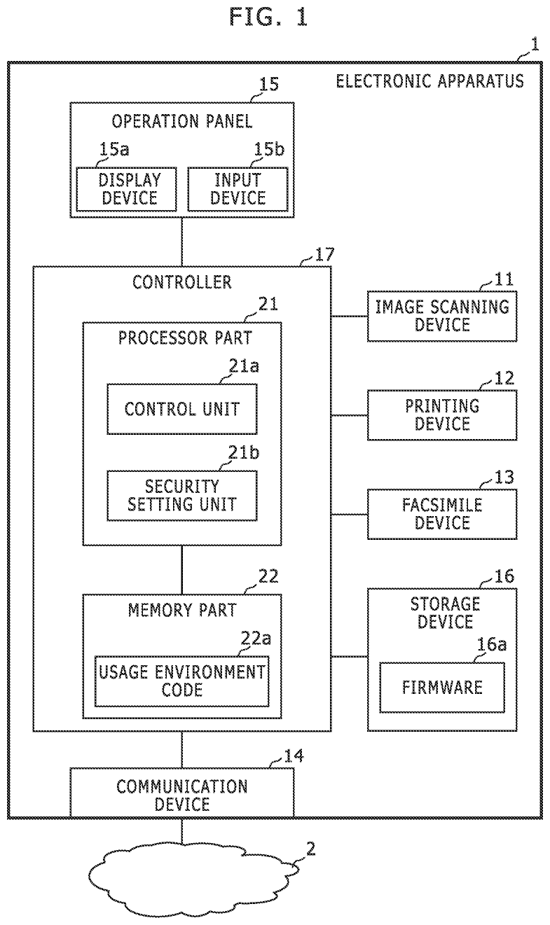

FIG. 1 shows a block diagram that indicates a configuration of an electronic apparatus according to an embodiment of the present disclosure. The electronic apparatus 1 shown in FIG. 1 is an image forming apparatus such as multi function peripheral, for example. The electronic apparatus 1 may be another electronic apparatus that includes a built-in embedded system, than an image forming apparatus. The electronic apparatus 1 shown in FIG. 1 includes an image scanning device 11, a printing device 12, a facsimile device 13, a communication device 14, an operation panel 15, a storage device 16, and a controller 17.

The image scanning unit 11 is an internal device that optically scans with a specified resolution a document image from a document put on a platen glass or a document fed by an auto document feeder, and generates image data of the document image. The printing device 12 is an internal device that prints the document image or the like in accordance with an electrophotographic manner or an inkjet manner. The facsimile device 13 is an internal device that transmits the image data obtained with the scanning as a facsimile signal, and receives a facsimile signal and generates an image data from it.

The communication device 14 is an internal device that includes a wireless or wired network interface, connects a network 2, and performs data communication using the network interface. The communication device 14 may include a wireless or wired peripheral device interface such as USB.

The operation panel 15 is arranged on an upper surface of a housing of the electronic apparatus, and includes a display device 15a that displays an operation screen to a user and an input device 15b that receives a user operation. The display device 15a is a crystal liquid display or the like, and the input device 15b is a hard key, a touch panel that forms a soft key with the display device 15a, and/or the like.

The storage device 16 is a rewritable non-volatile storage device such as flash memory, HDD (Hard Disk Drive) or SSD (Solid State Drive), and stores data and/or a program such as firmware 16a.

The controller 17 is a single IC chip such as ASIC (Application Specific Integrated Circuit), and includes (a) a processor part 21 that includes a CPU (Central Processing Unit), a RAM (Random Access Memory) and the like, and (b) a non-rewritable non-volatile memory part 22.

The processor part 21 loads a program stored in the memory part 22 or the storage device 16 to the RAM and executes the program using the CPU, and thereby acts as sorts of processing units. Here, the processor part 21 acts as a control unit 21a and a security setting unit 21b.

The memory part 22 is an OTP (One Time Programmable Read Only Memory) or the like, for example, and stores a system setting data that were written in a setting operation by an operator at a time point before an end user starts to use this electronic apparatus 1. This system setting data includes a usage environment code 22a. The usage environment code 22a is a code that specifies a usage or a destination among predetermined plural usages or predetermined plural destinations as a usage or a destination (a country or a region of the end user) of this electronic apparatus 1.

The control unit 21a controls the aforementioned internal devices and thereby performs sorts of processes such as a requested job. In this process, the control unit 21a is enabled to perform the process in accordance with one or more security algorithms.

The security setting unit 21b reads the usage environment code 22a from the memory part 22, selects a security algorithm in accordance with a value of the usage environment code 22a, and sets the selected security algorithm to this electronic apparatus 1.

Here, in accordance with the value of the usage environment code 22a, performed are (a) enablement or disablement of a security algorithm installed in the electronic apparatus 1 and (b) selection of a security algorithm to be used among plural security algorithms installed in the electronic apparatus 1.

Specifically, the security setting unit 21b determines a security algorithm to be applied to a specific process performed by the control unit 21a, before performing the specific process, in accordance with the value of the usage environment code 22a.

For example, the aforementioned security algorithms include a secure boot algorithm, the security setting unit 21b determines whether secure boot should be selected or not on the basis of the usage environment code 22a when the electronic apparatus 1 starts. If the secure boot algorithm is selected, the control unit 21a executes the secure boot algorithm, and otherwise if not, executes a normal boot algorithm without any secure boot functions. It should be noted that the secure boot algorithm is an algorithm that performs a security-related process such as verification of a system program in boot.

Further, the aforementioned security algorithms include an encryption algorithm. This encryption algorithm is an encryption system (i.e. encrypting and decrypting manners) for encrypting data, a program and/or data communication. The security setting unit 21b performs (a) determination of whether the encryption algorithm should be applied or not, (b) selection of an encryption algorithm to be used among plural encryption algorithms (plural encryption systems), and/or the like, in accordance with the value of the usage environment code 22a. If it is determined that the encryption algorithm should be applied, the control unit 21a performs encryption and decryption of data, a program and/or data communication in accordance with the encryption system specified by the security setting unit 21b. Specifically, when data or a program is written in or transmitted, encryption of the data or the program is performed in accordance with the encryption system; and when data or a program is read out or received, decryption of the data or the program is performed in accordance with the encryption system.

The aforementioned data and/or program include(s) the firmware 16a (a program or the like executed by the processor part 21a) stored in the storage device 16, for example. Therefore, this encryption algorithm is applied to update of the firmware 16 or the like.

Further, the aforementioned data and/or program include(s) print data for the printing device 12 (image data of an image to be printed). It should be noted that this print data is temporarily stored in the storage device 16 or the RAM.

Further, the aforementioned data and/or program may include user setting data (setting data editable by a user) stored in the storage device 16, or may include user document image data (a user's document image data stored in a document box, or the like), for example.

For example, even if different encryption algorithms are allowed in different destinations (or different encryption algorithms are prohibited or should be evaded in different destinations, the encryption algorithm corresponding to the value of the usage environment code 22a (i.e. corresponding to a destination of this electronic apparatus 1) is automatically and properly applied without a manual operation to directly and individually specify the security algorithm corresponding to the destination.

Further, for example, even if there are sorts of usages such as a usage that requires a short boot time, a usage that requires a high security level and the like, switching on/off the secure boot algorithm is automatically and properly set in accordance with the value of the usage environment code 22a (i.e. in accordance with a usage of this electronic apparatus 1).

The following part explains the aforementioned electronic apparatus 1.

In accordance with a setting operation at a time point before an end user starts to use the electronic apparatus 1, the control unit 21a writes a usage environment code 22a into the memory part 22. Afterward, the usage environment code 22a keeps a non-rewritable state, and the electronic apparatus 1 is installed at a site of the end user.

In the electronic apparatus 1, when the electronic apparatus 1 starts itself or starts a predetermined process, the security setting unit 21b reads the usage environment code 22a from the memory part 22, and specifies to the control unit 21a a security algorithm corresponding to a value of the usage environment code 22a. The control unit 21a performs boot (a boot process) or a specific process (e.g. a printing process) in accordance with the specified security algorithm.

As mentioned, in the aforementioned embodiment, the memory part 22 is a non-rewritable memory that stores a usage environment code 22a, and the security setting unit 21b reads the usage environment code 22a from the memory part 22, selects a security algorithm in accordance with a value of the usage environment code 22a, and sets the selected security algorithm to this electronic apparatus 1.

Consequently, individual security setting is not required, a setting operation gets simple at a time point before an end user starts to use the electronic apparatus 1, and incorrect setting on security is restrained.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the memory part 22 is included in the IC chip of the controller 17. Alternatively, an external storage device connected to the IC chip of the controller 17 may be used as the memory part 22.

What is claimed is:

1. An electronic apparatus, comprising:
a non-rewritable memory part configured to store a usage environment code; and
a security setting unit configured to read the usage environment code from the memory part, select a security algorithm in accordance with a value of the usage environment code, and set the selected security algorithm to the electronic apparatus.

2. The electronic apparatus according to claim 1, wherein the security algorithm is a secure boot algorithm.

3. The electronic apparatus according to claim 1, wherein the security algorithm is an encryption algorithm.

4. The electronic apparatus according to claim 3, wherein the security setting unit selects the encryption algorithm among predetermined plural encryption algorithms in accordance with the value of the usage environment code, and sets the selected encryption algorithm to the electronic apparatus.

5. The electronic apparatus according to claim 3, further comprising a rewritable non-volatile storage device that stores firmware;
wherein the security setting unit sets encrypted firmware as the firmware, the encrypted firmware based on the encryption algorithm.

6. The electronic apparatus according to claim 3, further comprising a printing device;
wherein the security setting unit sets encrypted print data as print data for the printing device, the encrypted print data based on the encryption algorithm.

7. The electronic apparatus according to claim 1, wherein the usage environment code is a code that specifies a usage or a destination of the electronic apparatus.

8. The electronic apparatus according to claim 1, wherein
the security setting unit is installed as a processor part built in an IC chip; and
the memory part is built in the IC chip.
